(19) United States
(12) Patent Application Publication
(10) Pub. No.: US 2009/0006083 A1
(43) Pub. Date: Jan. 1, 2009

(54) Systems And Methods For Spoken Information

(76) Inventor: William R. Bachand, Phoenix, AZ (US)

Correspondence Address: Bachand Law Office, P.O. Box 54244, Phoenix, AZ, 85078, US

(21) Appl. No.: 11/772,134

(22) Filed: Jun. 30, 2007

(51) Int. Cl. G10L 19/00

(52) U.S. Cl. 704/201

(57) ABSTRACT

A communication system, according to various aspects of the present invention, communicates via a network with a person who operates a voice input/output device. The communication system provides collecting and reporting services for journals and surveys all via spoken information. The communication system includes a meta-data database, a constructing engine, and a conversing engine. The constructing engine directs collecting of meta-data directs constructing a journal in accordance with the meta-data database. The conversing engine collects the meta-data from the person for storage in the meta-data database and collects data from the person for storage in the journal. The conversing engine collects further spoken information for a survey.

### FIELD OF THE INVENTION

Embodiments of the present invention relate to computer systems and computer programming for spoken information.

### BACKGROUND OF THE INVENTION

The conventional telephone provides an audio input/output device suitable for persons to interact with a conventional automated interactive voice response (IVR) communication system. The persons and IVR systems may be geographically separate. The links between the persons and IVR systems may cross political boundaries. These features can provide economic benefits to the service that operates the IVR systems. Persons may place a telephone call that is answered by a conventional IVR system that, due to its programming, screens calls, routes calls to particular human operators or message delivery systems, and plays advertising messages to the person, all to the benefit of the service that operates the IVR system. A conventional IVR system of the type described by U.S. Pat. No. 7,110,952 to Kursh, incorporated herein by reference, according to its programming, may place a telephone call to a selected person for accounting of business expenses and presenting targeted advertising of products for sale, all to the benefit of the service that operates the IVR system. Other systems use IVR technology to confirm medical appointments for increasing clinic profitability and to deliver medical test results for fulfilling a professional obligation.

Although both the person and the IVR system communicate spoken information, the person interacting with a conventional IVR system has little control of the conversation, except to discontinue it. The person can feel controlled to respond only in ways that are foreseeable by the service and its programmers. The person who places a call that is answered by the conventional IVR system may be annoyed when the IVR system, due to its stilted preprogramming, artificial assumptions, and failures to appreciate the person's particular purpose of the call. More so, the person who receives a call from an IVR system may be initially unwilling or soon become unwilling to cooperate as intended by the preprogramming. Consequently, conventional IVR technology is unsuitable for many man-machine exchanges of spoken information.

Without systems and methods of the present invention, persons and services cannot mutually benefit from the convenience of exchanging spoken information.

### BRIEF DESCRIPTION OF THE DRAWING

Embodiments of the present invention will now be further described with reference to the drawing, wherein like designations denote like elements, and:

FIG. 1 is a functional block diagram of a communication system according to various aspects of the present invention; and

FIG. 2 is an entity relationship diagram of a meta-data database used in the system of FIG. 1.

### DETAILED DESCRIPTION OF THE PREFERRED EMBODIMENTS

A communication system, according to various aspects of the present invention, communicates with persons (herein interchangeably called Customers or prospects) by exchanging spoken information. The communication system overcomes the problems discussed above at least in part by redistributing the costs and benefits of spoken information exchange across a man-machine interface. For example, the communication system may be operated for the benefit of a service provider (herein called the Company) for its profit, yet greater profits may be realized by the Company because the communication system, according to various aspects of the present invention, includes capabilities to perform: (a) services that primarily benefit the Company; and (b) services that primarily benefit the Customers. Although a Customer may occasionally be annoyed by communications initiated by the communication system and/or annoyed by having to tolerate a perceived lack of understanding or flexibility when the communication system is pursuing the Company's interests, these costs may be balanced by benefits to the Customer due to the communication system's ability to accomplish one or more of the Customer's purposes. The Company may view serving the Customer's purposes as a cost, but this cost may be balanced by obtaining, as a result of serving the Customer's purposes, increased cooperation of Customers with the communication system.

Benefits to the Customer may act as incentives for encouraging Customers to cooperate with the Company's purposes for the communication system, thereby increasing the Company's profits compared to use of conventional IVR systems. Of course, the Company may collect fees for providing Customer benefits as much as the market will bear. The Company may offer respective discounted fees and/or free services as Customer benefits based on the extent of cooperation by the Customer.

Benefits to the Customer may include the availability of accurate and convenient collecting and reporting of spoken information performed by a communication system according to various aspects of the present invention and thereby facilitate benefits to the Company. For example, in one application of a communication system according to various aspects of the present invention, the Company desires to conduct various surveys and sell the results for profit. Each survey will be conducted according to a questionnaire in a spoken information exchange with a Customer that meets the qualifications for being included in the sample. Instead of advertising to attract qualified persons as members of the sample, the Company may advertise the ability of a personal assistant to collect and report a type of information that may appeal to qualified persons. For instance, the Company may develop a voice profile for each of several voice personas projected by the communication system. It may then advertise that a particular voice persona is available as a personal assistant to journal, organize, and report information for respective Customers who participate from time to time in various surveys. This benefit may mitigate the misgivings of persons to participate in surveys that would otherwise take up their time and energy without adequate compensation.

The information to be collected and reported may be specified from time to time and uniquely by each Customer. Some examples of expected information that may appeal to large percentages of the public include personal experiences, costs of ownership of personal or real property (e.g., autos, houses, rental units), pleasure travel expenses, budget expenditures, and/or shopping lists (e.g., necessities, gift ideas, competitive prices), aspects of hobbies, contact information, news, weather, upcoming events, and behavior intended to be changed (e.g., eating on a diet, personal medication, personal exercise, behaviors of others, disciplines, rewards). Persons who operate businesses may desire to organize personal information as discussed above and/or information related to sales prospects, business expenses related to each of several projects, client billing for time and expenses, business travel expenses, investment opportunities, costs of ownership of property used for business or investment, supplies on hand, inventory, commitments, tentative arrangements, competitive intelligence, legal issues, press releases, and business advice given and/or received.

Collecting information may include soliciting, perceiving, storing, and organizing information. These functions may be understood to be included in automated journaling. Manual journaling includes analogous functions such as preparing a journal, keeping the journal by making entries in an organized manner, and reading from the journal. A communication system, according to various aspects of the present invention, collects and reports information to be journaled that is spread over time and varies by Customer. The communication system may receive, process, and output spoken information in accordance with the respective directions of each Customer. For the Customer, these capabilities may produce additional benefits. For example, information that a Customer becomes aware of from time to time may be challenging or time consuming to journal and organize (e.g., classify, sort, analyze, track) by prior art techniques including the unaided human memory, handwriting, and conventional manual data entry (e.g., using a personal computer, personal digital assistant, electronic notebook). A communication system according to various aspects of the present invention may journal information for intermediate reporting (e.g., progress, remaining amounts) and/or final reporting (e.g., totals, counts, summaries, tax returns). Different persons concerned with the same type of information may obtain from the communication system different organizations (e.g., selections, presentations, sorts, totals, counts, classifications, conformation to various tax laws, various data derived from the information) and/or reports varying in availability (e.g., automatically produced, produced on demand), content, and format (e.g., mailed printout, emailed spreadsheet, spoken narrative). For instance, diet information may be journaled on demand by the system via spoken information exchange as food and recipe names and servings or quantities and reported on demand by the Customer via spoken information exchange as calories per food group remaining toward daily total diet goals.

According to various aspects of the present invention, a communication system may include personas for conversation with a Customer to exchange spoken information. Conventional interactive voice response technology may be used to create each persona (e.g., recorded voice talent, synthesized voice, vocabularies, script phrases, scripts). The persona may conduct a cold call to a prospective Customer. For instance a cold call may explain that collecting and reporting for Customer purposes is available in exchange for cooperation with one or more Company purposes (e.g., encouraging use of websites, selling products, obtaining and developing sales leads, conducting surveys). The persona may answer calls from Customers or initiate calls. For instance when a persona answers, the user may direct the purpose of the call (e.g., to update a journal, review journal content, ask a question and receive an answer based on any journal, design a new journal, order a report to be sent by email, order products). A persona-initiated call to a Customer may be initiated to assure complete journaling (e.g., call a traveler at least daily to obtain descriptions of meals conducted for business purposes before the details are forgotten) and/or to assure complete reporting (e.g., Customer requested weekly status report). A call may be initiated to a Customer to pursue or complete a Company purpose (e.g., to obtain answers to a few survey questions).

The Company, having attracted a suitable number of Customers who are appreciating benefits from the communication system, may choose a sample of Customers for a survey and include questions and/or information from a suitable questionnaire in one or more conversations between the Customer and a persona. The communication system may accommodate Customer selection of one or more personas for various journaling and/or reporting functions. The communication system may accommodate Company selection of one or more personas for Company purposes (e.g., the same persona for all Customers of a sample, a Company selection from a set of Customer preferred personas unique to each Customer, a persona unique to a Company purpose). Consequently, greater participation in each survey can be expected because the participants have an incentive to cooperate, are familiar with conversing with the communication system for their own purposes, and have greater appreciation for the capabilities and limitations of the communication system. The questionnaire may be brief or may be conducted in brief stages on several calls. The Company may receive revenue from Customers for collecting and reporting as well as from sales of the results of surveys (e.g., printed reports) that were efficiently and accurately conducted.

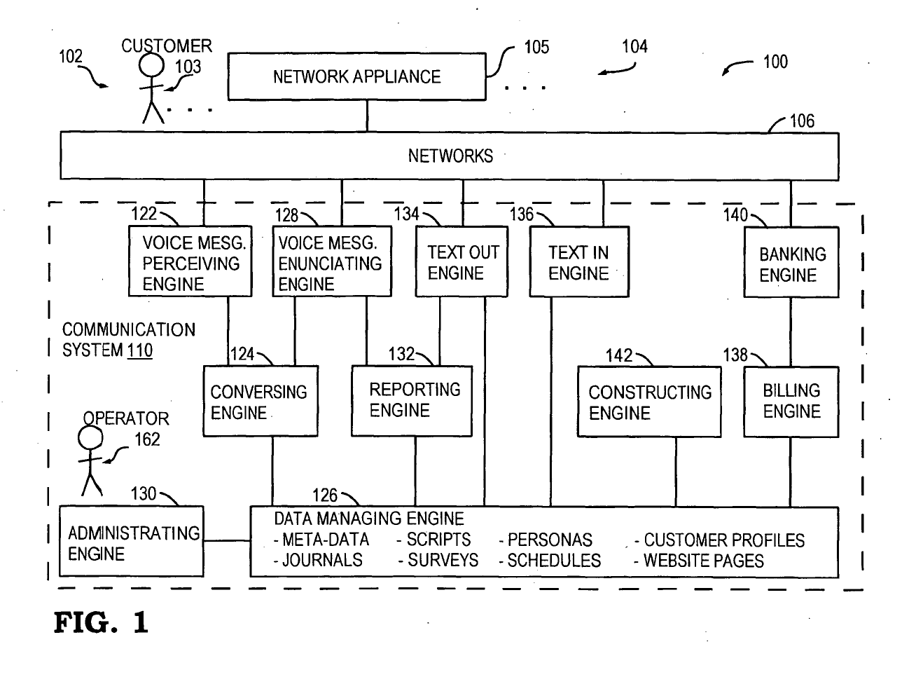

A networked communication system, according to various aspects of the present invention and as discussed above, may be constructed and programmed using conventional technologies in combination with the teachings of the present invention. For example, networked communication system 100 of FIG. 1 exchanges spoken information with a plurality of persons 102 who may be customers or prospects of which Customer 103 is exemplary, each using a respective network appliance 104. Networked communication system 100 includes a plurality of network appliances 104 of which network appliance 105 used by Customer 103 is exemplary.

Networked communication system 100 may further include a plurality of networks 106 and a plurality of communication systems of which communication system 110 is exemplary. A network may include a wireless network, telephone network, mobile phone network, cellular network, satellite network, intranet, and/or the Internet. The communication of spoken information may be made during a phone call or a website session (e.g., audio content, Voice Over Internet Protocol).

A communication system 110 may be hosted on one or more servers and distributed geographically. Each network appliance 105 and each communication system 110 is coupled as needed to one or more networks 106 for a conversation having a duration and herein also referred to as a call. A communication system 110 may project one or more personas for communicating with one or more Customers. Each conversation implements an exchange of spoken information, for example, as discussed above.

Each conversation may include one or more personas of the communication system and one or more Customers. Communicating between one persona and one Customer may be sufficient for journaling as discussed herein. A change of persona may be used to indicate a change of context in the same or different calls (e.g., preferred persona for journaling, Company persona for billing, surveyor persona for conducting a survey). More than one person and one persona on a call may be suitable for training, troubleshooting, mediating, advising, and/or collecting spoken information for comparative or translation purposes. One Customer and more than one persona on a call may be suitable for introducing and/or selecting a persona. To assist a Customer in responding to a script (e.g., interpreting, explaining, adding interest, assuring efficient collecting), a second persona (e.g., with a second script) may be projected during the call and synchronized with the first persona and the Customer.

Communication system 110 includes voice message perceiving engine 122, conversing engine 124, data managing engine 126, voice message enunciating engine 128, administrating engine 130, reporting engine 132, text out engine 134, text in engine 136, billing engine 138, banking engine 140, and constructing engine 142. For clarity of the following discussion, it is assumed that operator 162 controls communication system 110 for the Company as discussed above.

An engine may be implemented with any combination of hardware, firmware, and software for performing the functions of the engine including producing the primary output of the engine. An engine may be hosted on a server and may have access to data storage unique to the functions of the engine (e.g., databases of configuration information, reference materials, workspaces, data exchange with other engines, accounts, conversations, sessions, current state, programming and workspaces for agents). Data storage may be shared in any conventional manner among engines. The output of an engine may be used by any other engine for concurrent operation of the two engines or with intermediate storage at the interface between the two engines. Engines communicate using any conventional inter-process communication (IPC) technology (e.g., Distributed Computing Environment, MBUS RFC 3259, XML, XML-RPC, sockets, CORBA, Microsoft Distributed Component Object Model, Dynamic Data Exchange, Object Linking and Embedding, Active Directory, SQL).

Each set of functions is herein attributed to a respective engine for convenience of discussion. The eleven sets for eleven engines in FIG. 1 do not necessarily imply a one-to-one implementation of engines to physically separate computers. The eleven engines of FIG. 1 may be implemented on any number of computers (e.g., servers, processors, subsystems) A computer includes any programmed processor and suitable memory, software, interfaces, and peripherals that hosts one or more sets and/or one or more parts of sets of the functions attributed to engines discussed herein.

More than one engine may be implemented on a server (e.g., a computer). Communication (e.g., IPC) between engines and/or servers may be implemented with any network technology. Some functions of an engine as discussed above may be divided between servers. For instance, a first server may host engines 122, 124, 128, suitable functions of engine 130, and suitable functions of engine 126. A second server may host engines 132, 134, 136, suitable functions of engine 130, and suitable functions of engine 126. The first and second servers may communicate via a network (e.g., 106 and/or a network not shown) for seamless operation of all functions of engines 130 and 126. Other implementations of system 110 employ other suitable combinations and splits of engine functions and may employ secure networks (e.g., networks 106 with security and/or physically different networks).

Perceiving may include receiving, decomposing, describing, and/or storing a result of perceiving (e.g., which one of several choices the Customer's response indicates is his or her choice). Receiving may include the functions of audio signal circuits (analog and/or digital) and software (e.g., frequency analysis, pattern recognition, phoneme recognition). Decomposing may include discriminating, parsing, classifying, sorting, selecting, analyzing, describing, and/or validating. Discriminating may include measuring, comparing, matching, and testing. Analyzing may include comparing results of discriminating, parsing, and selecting to standards (e.g., vocabularies, rules of grammar). Describing may format the results of analyzing into a suitable data structure for validating or for finding a best fit based on the meaning attributed to the spoken information. Validating may include accepting portions of the description, rejecting alternative meanings, and/or preparing a figure of merit describing how well a result of perceiving matches the selected choice or each of the choices.

A voice message perceiving engine includes any engine that relates a voice message (e.g., audio, digitized audio, packets from conventional voice networks) received from a network to message data so that the message data may be the subject of logical analysis. Logical analysis includes any data processing according to a meaning intended by the voice message (e.g., semantic logic, procedural logic, system operational logic). For example, in a simple perceiving engine, of the type described by U.S. Pat. No. 4,087,632 to Hafer, incorporated herein by reference, only a few expected voice responses are perceived. The input from the network may be conditioned (e.g., amplified, biased, normalized in amplitude and frequency content, scaled) and compared to expected responses using a best fit selection strategy. Data corresponding to the expected response is then output from the voice message perceiving engine. In a more sophisticated perceiving engine, of the type described in U.S. Pat. No. 6,292,775 to Holmes, incorporated herein by reference, words and word forms are recognized. These words and word forms form the basis of a search among numerous expected responses for a best fit with corresponding data as in the earlier example. In a still more sophisticated perceiving engine, the voice message is analyzed to recognize words that are then classified according to a grammar as to parts of speech.

The output of a voice message perceiving engine may include a determination of which of several proffered choices was accepted, one or more data structures each representing one or more sentences. This output may be used to determine an appropriate response by the persona.

The output of a voice message perceiving engine may include information to be taken as one or more values (e.g., data, meta-data) for posting. Posting may include storing replacement information (e.g., new values, and updates) or storing an edit to information already posted. Posting may affect one or more fields of one or more records of one or more tables The output may be in a conventional value format (e.g., transcribed text string) and/or a markup language (e.g., VXML or XML).

For example, voice message perceiving engine 122 receives voice message information for one or more simultaneous messages in any conventional format from networks 106 and provides to conversing engine 124 information sufficient for logical analysis of the message. When the Customer's choice is determined, voice message perceiving engine 122 output may be sufficient to follow the preprogrammed logic of the conversation (e.g., a tree or script) to the next node (e.g., preparing a reply to be enunciated by a persona). The output may refer to the current tree or script or refer to a new tree or script, for example, that provides for the situation where the Customer's spoken information provides no meaning or choice, fails validation, indicates a departure from the script, or indicates another script would be suitable for continuing the conversation.

A conversing engine includes any engine that performs the logical analysis to conduct in substantially real time an exchange of spoken information with a human Customer. Conversing includes conventional logic implemented in interactive voice response systems (e.g., predefined messages to be given to the Customer and decision trees driven by data corresponding to expected responses as discussed above). A conversing engine may be implemented using conventional IVR technology. Conventional technology may seem to the Customer to be stilted if the logic of the conversation is substantially constrained to limited subject matter, choices, and expected responses. Conversing, according to various aspects of the present invention, includes logic sufficient to perceive and respond to a change in subject matter initiated by the Customer. According to various aspects of the present invention, conversing may include logic for requesting and receiving data from a Customer, logic for requesting and receiving meta-data, and/or logic for recognizing meta-meta-data (e.g., Customer asks to change the value of a column heading in a report by saying the phrase “column heading”). For example, conversing engine 124 receives data corresponding to voice messages from voice message perceiving engine 122, recognizes the logic of the data (e.g., significance) and initiates a logical response to it (if any). The logic of input data may be recognized as significant (e.g., be part of, correspond to, or be related to) to any message for initiating or completing a function of a communication system as discussed herein. A response (e.g., an answer to a question put to the Customer by communication system 110) may be significant for selecting to use an existing journal, for specifying a new journal, for making an entry in an existing journal, for posting as an opinion for a survey, for handling as a request for a report, for handling as a request for any customer service function of system 110, and/or for placing a purchase order.

With reference to logic (e.g., courtesy protocols, persona protocols, scripts, questionnaires, surveys) of engine 124 (e.g., program code, data or databases in engine 124) or logic accessible to engine 124 (data requested of and received from data managing engine 126), conversing engine may (a) direct data managing engine 126 in any manner discussed below (e.g., query, post, control an agent) to analyze or act on the informational content of the input data; and/or (b) prepare output data corresponding to a spoken message and pass the output data to voice message enunciating engine 128. Output data from a conversing engine may also be stored by a data managing engine for use (e.g., scheduled or substantially immediate) by any other engine of communication system 110. Output data may be in any conventional format (e.g., SQL, VXML, XML, IPC as discussed above).

A data managing engine performs any set of conventional data storage and retrieval functions where the data may include executables and/or values in any conventional format. Executables may include scripts, java applets, and/or program code. Values may includes values referred to by executables, manipulated by executables, and/or processed through executables. Formats may include computational formats, audio formats, normalized formats, data structures, records, SQL, VXML, XML, and/or IPC as discussed above. For example, data managing engine 126 may include conventional servers coupled to fault tolerant storage area networks and storage devices. Data managing engine 126 may host database management software including database performance optimization software (e.g., used manually by operator 162, used automatically by administrating engine 130). Ad hoc requests for storage (e.g., posting, instantiating) and/or retrieval (e.g., querying) may be received in any conventional manner from conversing engine 124, administrating engine 130, reporting engine 132, text out engine 134, text in engine 136, billing engine 138, and/or constructing engine 142. Retrieved data may be presented to the requesting engine in any conventional format (e.g., a format unique to the requesting engine, a universal format, a computer industry standard format, any IPC format discussed above). Data managing engine 126 may include agents that perform any of the functions discussed herein with respect to data being managed. Data managing engine 126 includes one or more databases for managing meta-data, journals, scripts, surveys, questionnaires, personas, schedules, agents, customer profiles, and/or website pages (e.g., for reporting and/or assisting Customer edits of data and meta-data).

A voice message enunciating engine includes any engine that accepts data representing spoken information and outputs to a network in a format acceptable to the network sufficient information for producing an audio version of the spoken information to be heard by a human via a network appliance. A voice message enunciating engine may include the capability to present information according to one or more conventional voice personas (e.g., recorded voice talent or synthesized voices). A voice message enunciating engine may include logic for further processing the message (e.g., pacing, inflection, courtesy protocols, dialect, substitute word choices). For example, voice message enunciating engine 128 converts output data received from a conversing engine to information of the type accepted by networks 106 for one or more substantially simultaneous conversations with one or more Customers or prospects 102.

An administrating engine includes any engine that configures, initializes, updates, schedules changes, monitors, controls, and/or handles exceptional conditions for any engine of communication system 110. Administrating may include accomplishing any Company goal, including, for example, establishing and maintaining a quality of service with respect to Customers; maintaining level use of networks, processing resources, and data storage resources; directing promotion of the Company's services to prospects (e.g., potential survey respondents, potential businesses needing survey results, potential purchasers of journaling capacity), conducting market research regarding Customer-defined journaling (profiling Customers, usage analysis, cost benefit analysis, pricing); conducting market research for others; conducting public opinion and brand value/loyalty research for the Company or for others; operating communication systems for profit. For example, administrating engine 130 communicates in any conventional manner with data managing engine 126 to store information (e.g., for initializing, for updating) that is used by each other engine of communication system 110 (administrative links to engines omitted from FIG. 1 for clarity). Administrating engine 130 and data managing engine 126 may cooperate to define, instantiate, schedule, monitor, control, provide inputs to, receive outputs from, and terminate any number of agents that may operate in either or both of engines 130 and 126 to accomplish the goals discussed above. An agent includes any process that performs an ad hoc function within communication system 110. For example agents may obtain payments from Customers for services rendered by communication system 110; profile Customers over a period of usage of system 110 by the Customers; identify and empanel Customers for particular surveys; sell subscriptions for services (e.g., collecting, reporting, journaling, surveying) provided by system 110 (selecting prospects, promoting, obtaining subscription sales commitments); eliminate inconsistencies among records, tables, sessions, and Customers with respect to data managed by data managing engine 126; contact Customers periodically to assure journals are complete and/or surveys are complete; establish report preparation schedules; forecast demand for system resources; host website sessions for Customers and prospects; create and update voice personas; send and receive email (e.g., reports, promotions); schedule the conduct of a survey for an entire panel where the survey is split into stages (e.g., each having a short questionnaire) suitable for short conversations; notify or inform all or a subset of Customers; manage the destruction of data; coordinate the presentation of information to Customers by combined audio and video for efficient use of resources; and manage the logic and data sufficient for correctly obtaining the identity of a Customer.

A reporting engine includes any engine that manages an information flow from a data managing engine to a Customer or prospect. A reporting engine may initiate the preparation of reports or be directed by a data managing engine to prepare reports. The content and delivery of reports may be specified to a reporting engine by a data managing engine on request by a reporting engine or as initiated by an agent as discussed above. Reports may be delivered via a voice message enunciating engine or a text out engine. Reports may include any conventional content and format. For example, reporting engine 132 initiates queries to data managing engine 126 to identify reports to be prepared and content for reports; receives data, meta-data, and meta-meta-data from data managing engine 126; prepares the reports by making queries of Customer journals and/or queries of Company journals (e.g., data for administrating as discussed above, Customer lists, price lists); and provides information in cooperation with voice message enunciating engine 128 and text out engine 134 to assure complete and timely delivery of the reports. These functions may be accomplished by reporting engine 132 substantially simultaneously (e.g., on multiple threads) for any number of Customers 102, agents, and operator 162. Outputs of reporting engine 132 to data managing engine 126 may conform to any conventional format (e.g., SQL). Outputs of reporting engine 132 to voice message enunciating engine 128 and text out engine 134 may conform to any conventional format including any format unique to these engines or a standard format among all engines of system 110.

A text out engine includes any engine that sends a message to be read by a Customer, prospect, or operator. A text out engine may use any conventional text protocols and technologies including text messaging (e.g., to cell phones and pagers), email, and/or internet website protocols. For example, text out engine 134 includes a text messaging capability for alarms, short prompts, announcements (e.g., rewards), and brief reports. Text out engine 134 may include an email sending technology (e.g., of the type known as sendmail by Sendmail, Inc.) for explaining services, providing proofs of report forms, providing reports, and soliciting. Text out engine 134 includes website hosting technology (e.g., of the type known as Apache HTTP Server, MySQL, PHP, Perl, DNS Service available from www.devside.net) for conducting sessions with Customers and prospects for editing journals, validating Customer profiles (e.g., assuring comprehensive identification processes), bulk data transfers (e.g., dictionaries and grammars for voice personas and voice message perceiving engines, survey scripts, interactive reports (e.g., hypertext linked hierarchical reports), and live reports (e.g., monitoring system utilization, monitoring survey completions).

A text in engine includes any engine that receives keyboard entry from a Customer, prospect, or operator. A text in engine may receive any keyboard entry protocol including DTMF, ASCII, and pointing device signals. A text in engine may use any conventional text protocols and technologies compatible for full duplex communication in cooperation with a text out engine. A text out engine and text in engine (in addition to the text capabilities discussed above) may cooperate to support any number of sessions having a conventional graphical user interface via a network 106 for communicating with a Customer, prospect, or operator. A text in engine may parse the envelope and message to determine suitable interaction with a data managing engine to compete a disposition of each message received from networks 106. For example text in engine 136 includes technologies for receiving text messaging, email, and website protocols; posting entries and updates to Company journals, Customer journals, and survey responses; and providing inputs to other engines for immediate or scheduled actions (e.g., cooperating with voice message perceiving engine 122 when a Customer replies with DTMF, keyboard, or pointing device input instead of speech.

A billing engine includes any engine that manages Customer accounts for subscriptions and or purchases. For example, billing engine 138 cooperates with data managing engine 126 to query and receive Customer profiles and payment information; to query and receive price lists and promotions information; to query and receive histories of services and/or resources used and subscribed to be used; and to query and receive payment histories and credit information. Billing engine 138 requests and tracks completion of timely transactions for collecting payments from Customers by cooperating with banking engine 140. In cases where payment fails, billing engine 138 determines a suitable next course of action and posts information to data managing engine (e.g., warning announcements needed, denial of services, reduction in use of resources, account closure). This information may be read by reporting engine 132 to prepare suitable reports for Customers 102 and/or operator 162. This information may be read by constructing engine 142 to prepare and schedule scripts for conversations with Customers 102.

A banking engine includes any engine that communicates over a network to conduct a financial inquiry or conduct a financial transaction. For example, banking engine 140 may communicate via conventional electronic funds transfer technology using network 106 (or private networks, not shown) with any credit bureau, government, or banking institution to credit the Company with payments from Customers.

A journal, according to various aspects of the present invention, may be a any database described by a meta-data database. For example, a journal may be any relational database described by any combination of records of meta-data database 200. At a minimum, a journal may have: (a) a title (e.g., so that a persona may prompt the Customer for the subject matter to be journaled); (b) one report having a title (e.g., so that a printed report is identified both to the Customer and to the communication system); (c) at least one column in the report, the column having a column-name (e.g., so that characteristics of the column may take at least default values such as text); and (d) one table having one field, the title for the table may default to the title for the report, and the field may have the same column-name as the column-name used in the report. All other features may be omitted or assigned suitable default values. Default values may be implemented for several purposes: first, to minimize any reliance of the system on the Customer's prior experience with journaling, second, to simplify the conversation with a Customer, third to avoid long duration calls, and fourth, to encourage use of the system at an entry level.

A constructing engine includes any engine that directs preparation of journals and/or prepares journals for use by Customers. Preparation of a journal may include determining meta-data sufficient to instantiate a journal and directing the instantiation. From the Customer's point of view, a constructing engine may be operative via spoken information. A constructing engine makes it possible for journals and reports as discussed above to be selected from standards and/or designed uniquely by each Customer. The definitions, selections, configurations, instantiations, and/or schedules for a journal may be determined and/or directed to be defined, selected, configured, instantiated, and/or scheduled by a constructing engine. The definitions, selections, configurations, instantiations, and/or schedules are accomplished at least in part in accordance with information spoken by a Customer.

A constructing engine may construct Customer-defined databases and data structures that accomplish the functions of journals and reports discussed herein. A data structure of the type described in programming languages (e.g., PL/1, C++) may be used to store a schema, table, or record of a database. Results of constructing may be delivered (e.g., passed, passed by reference, made accessible) to the one or more engines responsible for performing in accordance with the results. A data managing engine may be used as a repository for the results. For example, constructing engine 142 cooperates with data managing engine 126 to cooperate indirectly with conversing engine 124, reporting engine 132, and administrating engine 130. Constructing engine 142 queries data managing engine 126 to determine what constructing results are desired and when they are desired to be completed; prepares scripts and agents for collecting information for completing constructing; and posts the results in data managing engine 126 for access by any suitable engine of system 110. When the meta-data collection is completed, constructing engine 142 may initiate the instantiation of a journal (e.g., in cooperation with data managing engine 126) to be managed by data managing engine 126.

A constructing engine, according to various aspects of the present invention, may collect values used as meta-data and/or direct the collection of values used as meta-data. Information that describes a database (e.g., field names, data entry validation criteria, the arrangement of tables, indexes, reports) that is sufficient for performing conventional database functions (e.g., all or any subset of SQL functions) may be gathered and maintained in a meta-data database. Meta-data describes data. For example, in a journal for a Customer who is dieting, “journal title” is meta-data describing data having a value such as “What I Ate” (the journal title) spoken by the Customer. In this example, voice message enunciating engine 128 asks the Customer to provide the data corresponding to the meta-data “journal title”. Meta-meta-data describes meta-data. Continuing with the example of a dieter's journal, the term “field name” is meta-meta-data, the Customer-provided values for field names (e.g., “Date”, “Time”, “Food”, “Quantity”) are meta-data, and values spoken by the Customer (e.g., “today”, “8:12 AM”, “coffee”, “one cup”) are data. Any number of journals that are identical in structure may be instantiated, initialized, maintained, and reported from using a common set of meta-data. If communication system 110 did not already have a set of meta-data for a dieter's journal, constructing engine 142 may prepare a script that includes prompts to ask the Customer to provide sufficient meta-data for basic functionality. Construction engine 142 may supplement the Customer-provided meta-data with additional meta-data. To ask the Customer for meta-data, a prompt to the Customer may include meta-meta-data (e.g., “What shall we use for the first column heading?” where “column heading” is meta-meta-data).

A meta-data database includes any data storage technology that supports creating and managing a journal as discussed herein. Journals may be constructed from information spoken by the Customer. A meta-data database may be accessed by any engine of communication system 110 for verifying or updating contents of the meta-data database. The meta-data database may comprise a conventional relational database configured for the functions and structures discussed herein.

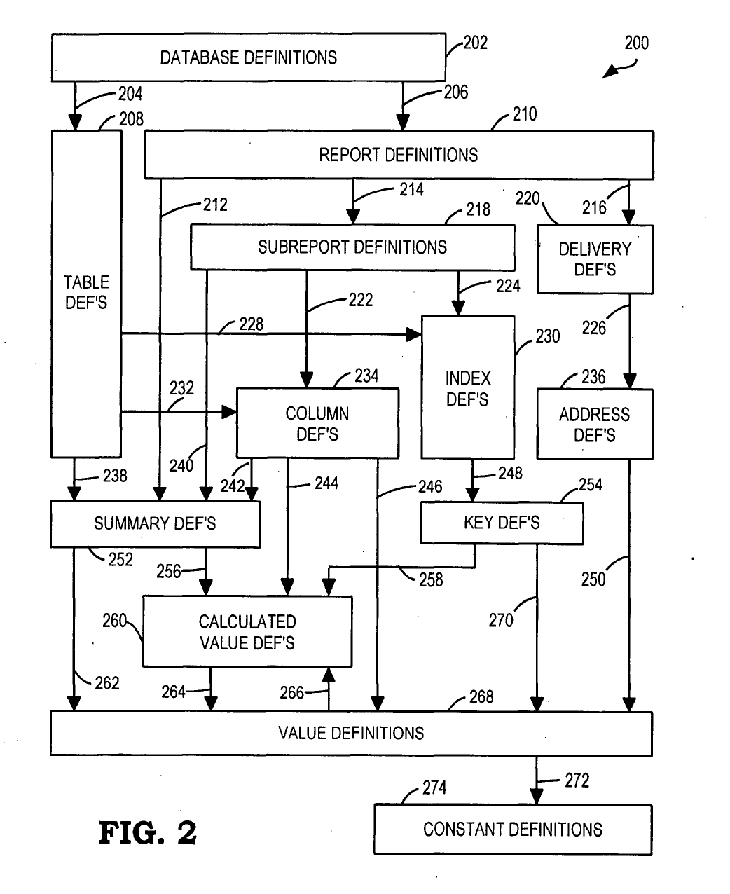

For example, meta-data database 200 of FIG. 2 is hosted by data managing engine 126 and/or constructing engine 142. Meta-data database 200 includes tables and links between tables. A table comprises a plurality of records. A record comprises a plurality of values (more precisely a tuple or set of field values) in one-to-one relation, some fields of which may be key fields having key values for indexed access to the record. A link comprises a table that relates one or more of the records of each of one or more tables (e.g., a cross reference to accomplish a one-to-many relation and/or a many-to-many relation). By creating or updating a record in meta-data database 200, an association is formed between the values in the fields of the record. By creating, or updating a link between records, an association is formed between the values in the fields of the records affected by the link.

In the entity relationship diagram of FIG. 2, each box represents a table and each arrow represents a link. Each link may be interpreted to mean “including” or “having”. For instance, a database definition “has” one or more table definitions and “has” one or more report definitions. Each plural represents one or more records of the respective table. Each table includes a field for a conventional efficient identifier (e.g., database-definition-id) used as its key field for index access to the table. The identifier value may be unique to each record. The identifier value may be used in one or more links as a key value or part of a key value (e.g., a foreign key or part of a compound key such as a key-pair).

One meta-data database may hold definitions for all types of journals used by communication system 110. Each new journal definition is defined by a plurality of records posted to meta-data database 200. A journal definition may be obtained from a Customer according to a script that may be prepared by constructing engine 142 to be followed by conversing engine 124. Each journal may be instantiated (e.g., space allocated for data to fill records for each table and link) according to a set of records of meta-data database 200. Instantiation may be directed by constructing engine 126 and accomplished by database managing engine 126.

The contents of each table of meta-data database 200 are described below in TABLE 1.

TABLE 1

| Table Comprising | | |
|---|---|---|
| Records | Information Stored | |
| Comprising Meta- | in a Record of the | |
| Data | Table | Description |
| database | database-name | title for Customer defined database (e.g., a journal |
| definitions 202 | | entitled “What I Ate”) and database-definition-id |
| | | used as a key field |
| | table-definitions | link 204 pairs a database-definition-id with each |
| | | related table-definition-id |
| | report-definitions | link 206 pairs a database-definition-id with each |
| | | related report-definition-id |
| table-definitions | table-ordinal | allows sequential processing of all tables in order of |
| 208 | | ordinal (e.g., 1, 2, 3) |
| | table-name | title for Customer-defined table (e.g., “Meals” |
| | | records foods and number of servings eaten; “Foods” |
| | | records general information about foods such as |
| | | calories per serving and serving size) |
| | table-index- | link 228 pairs a table-definition-id with each related |
| | definitions | index-definition-id; indexes may be used for |
| | | administrative access, collecting, reporting, and |
| | | calculated-value-expressions |
| | table-column- | link 232 pairs a table-definition-id with each related |
| | definitions | column-definition-id |
| | table-summary- | link 238 pairs a table-definition-id with each related |
| | definitions | summary-definition-id |
| report-definitions | report-ordinal | allows sequential processing of all reports in order of |
| 210 | | ordinal (e.g., 1, 2, 3) |
| | report-name | title for Customer-defined report (e.g., “Weekly |
| | | Progress”) |
| | delivery-definition | link 216 pairs a report-definition-id with each related |
| | | delivery-definition-id for automatic delivery of |
| | | reports to Customers |
| | subreport- | link 214 pairs a report-definition-id with each related |
| | definitions | subreport-definition-id; a report consists of at least |
| | | one group of records called a subreport (e.g., a diary |
| | | style report or multiple column report); a report may |
| | | have several groups of records (e.g., a master report) |
| | report-summary- | link 212 pairs a report-definition-id with each related |
| | definitions | summary-definition-id (e.g., including a grand total |
| | | formula) |
| delivery- | delivery-due-date | the next upcoming due date based on the delivery- |
| definitions 220 | | period and a start-date |
| | delivery-status | whether or not the delivery was successfully made |
| | delivery-period | shift, day, week, bi-week, month, quarter, annual, set- |
| | | of-dates |
| | delivery-address- | link 226 pairs a delivery-definition-id with each |
| | definitions | related address-definition-id |
| delivery-address- | address-ordinal | order in which delivery is attempted |
| definitions 236 | address-value- | link 250 pairs a delivery-address-definition-id with |
| | definition | each related value-definition-id, allowing various |
| | | kinds of contact information |
| subreport- | subreport-ordinal | allows sequential inclusion of groups of records into a |
| definitions 218 | | report in order of ordinal (e.g., first, second, third) |
| | subreport-name | title of the group of records |
| | subreport-index- | link 224 pairs a subreport-definition-id with each |
| | definition | related index-definition-id; defines how records for |
| | | the subreport are selected and sorted |
| | subreport-column- | link 222 pairs a subreport-definition-id with each |
| | definitions | related column-definition-id; a subreport includes one |
| | | column (e.g., a diary style report) or several columns |
| | | (e.g., a multiple column report) |
| | subreport- | link 240 pairs a subreport-definition-id with each |
| | summary- | related summary-definition-id; a summary definition |
| | definitions | describes the group of records (e.g., a subtotal) |
| (subreport or | index-ordinal | allows sequential use of indexes (e.g., for multi-level |
| table)-index- | | sorting where each sort may be on a compound key |
| definitions 230 | | such as date-time followed by lastname-firstname) |
| | index-name | title for Customer defined sorting order (e.g., “in date |
| | | order”) |
| | key-definitions | link 248 pairs an index-definition-id with each related |
| | | key-definition-id; several key definitions may be used |
| | | to define a compound key |
| key-definitions | key-ordinal | the ordinal may be used to specify an order in which |
| 254 | | the key is joined into a compound key definition; or |
| | | the ordinal may be used to reference a particular key |
| | | in a key expression |
| | key-direction | increasing or decreasing |
| | key-value- | link 270 pairs a key-definition-id with each related |
| | definition | value-definition-id allowing various kinds of |
| | | information to be used as a key |
| | key-value- | link 258 pairs a key-definition-id with each related |
| | expression | calculated-value-definition-id for calculated key |
| | | values; when more than one key-value-definition-id is |
| | | identified, the values (e.g., as identified by key- |
| | | ordinal) may be combined in a manner similar to a |
| | | formula in a cell of a spreadsheet |
| (subreport or | column-ordinal | allows columns to be arranged from left to right |
| table)-column- | | across a page |
| definitions 234 | column-name | title of a column as defined by the Customer; a |
| | | column-id (e.g., field name and/or field-id) may be |
| | | used in a table for efficient access |
| | column-value- | link 246 pairs a column-definition-id with each |
| | definition | related value-definition-id; signifies type, for |
| | | example, whether the key value is numeric or text |
| | cell-validation- | link 244 pairs a column-definition-id with each |
| | expression | related calculated-value-definition-id for validation; a |
| | | validation expression yields a binary value that |
| | | indicates whether a value meets the validation |
| | | criteria; validation criteria may be specified by |
| | | information spoken by a Customer, the expression |
| | | may be similar to a formula in a cell of a spreadsheet |
| | column-summary- | link 242 pairs a column-definition-id with each |
| | definitions | related summary-definition-id; summary definitions |
| | | may be used in cell-calculated-value-expressions |
| | | (e.g., current sum of column values, current average |
| | | of column values, maximum of current column |
| | | values) |
| | column-calculated- | link 244 pairs a column-definition-id with each |
| | value-expression | related calculated-value-definition for calculating a |
| | | cell value; a cell refers to the value for one row of this |
| | | column; if the cell is intended to represent a value |
| | | calculated from other cells in this row, an expression |
| | | similar to a formula in a cell of a spreadsheet may |
| | | refer to the values of other fields in the same record |
| | | (e.g., cost (current column) is calculated from |
| | | quantity times price) |
| (report, subreport, | summary-name | title of a summary value as specified by information |
| table, or column)- | | spoken by the Customer (e.g., “daily total calories”) |
| summary- | summary-value- | link 262 pairs a summary-definition-id with each |
| definitions 252 | definition | related value-definition-id; |
| | summary- | link 256 pairs a summary-definition-id with each |
| | validation- | calculated-value-expression-id for validation; a |
| | expression | validation expression yields a binary value that |
| | | indicates whether a summary value meets the |
| | | validation criteria; validation criteria may be |
| | | specified by information spoken by a Customer, the |
| | | expression may be similar to a formula in a cell of a |
| | | spreadsheet, for example the validation criteria may |
| | | indicate statistical significance based on at least a |
| | | minimum number of records in the group being |
| | | summarized. |
| | summary- | link 256 pairs a summary-definition-id with each |
| | calculated-value- | calculated-value-expression-id for calculating the |
| | expression | summary value |
| (key, summary, or | expression | values and validation are calculated using an |
| column)- | | expression similar to a formula in a cell of a |
| calculated-value- | | spreadsheet; an expression may include operators |
| expressions 260 | | (e.g., any arithmetic, logical, string operators), |
| | | predefined functions (e.g., maximum, minimum, |
| | | count, sum, average, moving average, first according |
| | | to index, next according to index), reference to any |
| | | value (e.g., by ordinal, a field in a record, a member |
| | | of a set for a summary, a field of the current table or |
| | | another table); all summary values for a subreport or |
| | | table may constitute one set (e.g., one data structure) |
| | | for reference in determining a calculated summary |
| | | value; the calculation may refer to other summary |
| | | values, constants, and/or other tables of this database |
| | | (e.g., estimated tax derived from a tax table and the |
| | | sum of net incomes in each row of a group of rows in |
| | | a subreport); for example budget-remaining |
| | result-value- | link 264 pairs a calculated-value-expression- |
| | definition | definition-id with each related value-definition-id; |
| | | allows expressions to have different types of resulting |
| | | values or be converted into suitable resulting values |
| (address, | value-class | describes a classification of the format of a value; for |
| summary, | | example, address-values may be any of: person-name |
| column, key, or | | (used for hand delivery), phone, FAX, land-mail, |
| result)-value- | | email, URL; other values may be any of: currency, |
| definitions 268 | | quantity, date, time, logical, set-of-constants, text, |
| | | pdf, url, audio, photo, audio-video |
| | value-unit-name | describes the unit of measure for quantitative values; |
| | | permits conversions (e.g., currencies, metric/english |
| | | quantities, time-zones, languages, and data exchange |
| | | formats) |
| | value-layout | each value-class can have its own set or range of |
| | | layouts; selection of a layout may be according to |
| | | information spoken by a Customer |
| | value-length | storage allowance (bytes) |
| | constant-definitions | link 272 pairs a value-definition-id with each related |
| | | constant-definition-id; constant definitions may be |
| | | used to describe suitable constants (e.g., members of |
| | | a set-of-constants) |
| | value-validation- | link 266 pairs a value-definition-id with each related |
| | expression | calculated-value-definition for validation |
| constant- | constant-ordinal | the ordinal may be used by an expression to reference |
| definitions 274 | | a particular member of a set-of-constants |
| | constant-class | a classification of the format of a constant's value; for |
| | | example, describes currency, quantity, date, time, |
| | | logical, set-of-constants, text, pdf, url, audio, photo, |
| | | audio-video |
| | constant-length | storage allowance (bytes) |
| | constant | value of the constant |

A constructing engine may direct collecting of meta-data by preparing a script or questionnaire for a conversation. The script or questionnaire may include explanations spoken to the Customer and questions asked of the Customer. The questions may include meta-meta-data (e.g., “What shall I use for the column heading?”) calling for a value for meta-data (e.g., Customer says “Food” and “Food” is then stored as the value in a record of a column-definitions table 234 for column-name). The script may be performed by a conversing engine in synchronism with the constructing engine as the script is being prepared; or, the script may be prepared in full first and then used at any convenient time by the conversing engine. For example, database managing engine 126 maintains a single comprehensive script for all collection of meta-data for a journal. The script may include choices of meta-data sets, choices among suggested values of meta-data, and/or prompting with meta-meta-data for a value to be used as meta-data. When conversing engine 124 determines that a Customer desires a new journal, the comprehensive script is accessed and performed by conversing engine 124. As (or after) meta-data is (or has been) collected (e.g., some or all of a conversation traversing the script is successfully completed), constructing engine 142 posts the meta-data in meta-data database 200. The meta-data for a journal is identifiable as a set. Constructing engine 142 directs data managing engine 126 to instantiate a journal according to the identified set.

According to various aspects of the present invention, a journal may be instantiated according to information spoken by a Customer when asked to describe or define a report. In other words, communication system 110 collects all information necessary to instantiate a journal and prepare a report from the journal by conducting a conversation according to a single script ostensibly about the report. The example conversation of TABLE 2, according to such a script, defines a dieting journal and a report. Conventional requests by communication system 110 for confirmation and recovery from potential misunderstandings and failures of perception are omitted for clarity but would be part of a practical script.

TABLE 2

| Voice Persona of Communication | | |
|---|---|---|
| System 110 | Customer | Comment |
| Hello, thank you for calling. My | learn more | The phrase “learn more” is perceived |
| name is Tracy and I am your | | because it closely matches one of the four |
| automated personal assistant. You | | given choices. |
| can call be anytime day or night. | | |
| You have four choices: Would | | |
| you like to talk now, learn more | | |
| about me, have me call back later, | | |
| or just go away? | | |
| When you call me, you will be | yeah, go ahead | Semantically, there are two positive |
| telling me what's happening with | | choices and two negative choices. The |
| you. I will make some notes of | | phoneme “yeah” matches the group of |
| what you say. Whenever you wish | | positive choices. Since there is no |
| you can call me to give you an | | phoneme match for “report” or “learn”, |
| organized report from my notes. I | | “get started with your information” is |
| keep all my friends separate and | | perceived as the closest match. |
| you are the only one with access to | | |
| your information. For a few | | |
| dollars a month I can keep track of | | |
| just about anything. The first 2 | | |
| months are free. You have four | | |
| choices: get started with your | | |
| information, learn about reports, | | |
| have me call back later, or just go | | |
| away? | | |
| Think about the information you'd | lets call it | Semantically, the phrase “lets call it” is |
| like me to track for you. I can | dieting | recognized as inappropriate to be |
| track lots of topics. For now, lets | | included in a title and is dropped. The |
| start with just one topic. Imagine | | remainder “dieting” is accepted as a title. |
| that I have a journal just for one | | “Title” is meta-meta-data. “dieting” is |
| type of information from you. | | meta-data. The journal-name, report- |
| What would you like me to use as | | name, and first subreport-name may all |
| the title for your first journal? | | be assigned “dieting” for basic |
| | | functionality. |
| For me to take good notes about | I think I need a | The word “table” is perceived because it |
| dieting, we need to talk about the | table | matches one of the choices. System 110 |
| report you'd like me to give you — | | now begins collecting information for the |
| what it looks like and what it says. | | first subreport. The same information is |
| Which of these two reports would | | used for table definitions. |
| you like: a diary style report or a | | |
| table of columns and rows? | | |
| Would you like me to use the date | sure | The Customer selected a set of meta-data |
| and time as the column heading for | | for the column headings of the first two |
| the first two columns? | | columns as opposed to being asked and |
| | | stating “date” and “time” meta-data |
| | | values. |
| I'll need a title for each column. | food | |
| Beginning on the left, what is the | | |
| title for the next column? | | |
| Is that the last column? | no | |
| What is the title for the next | Number of | |
| column? | servings I ate | |
| Is that the last column? | yes | |
| Would you like me to add a | yes | |
| column of calculated information? | | |
| What is the title for the first | calories | |
| calculated column? | | |
| Is that the last calculated column? | yes | |
| Should I calculate calories using | FDA is fine | System 110 recognizes that the column |
| the FDA table of serving sizes? | | headings “food”, “servings” and |
| | | “calories” imply some type of a |
| | | conversion. The questions is constructed |
| | | from information recalled from a query |
| | | of conversion tables available via data |
| | | managing engine 126. If the Customer |
| | | had said no, the system would connect |
| | | the Customer to a Customer service |
| | | person to complete the report definition. |
| How often would you like to get a | end of each | The word “week” matches one of the |
| report? | week | expected periods, “weekly” |
| Would you like daily summary | yes | System 110 presumes that daily |
| information? | | summaries would be appropriate for |
| | | many types of weekly reports and asks |
| | | for that information specifically. This |
| | | answer leads system 110 to apply a set of |
| | | meta-data for seven identical subreports |
| | | that select information for each day, sort |
| | | it by time of day, and insert summary |
| | | information at the end of each group. |
| What is the first summary value? | total calories | System 110 uses “total calories” for the |
| | | summary-name. Calories is recognized |
| | | as the title of the calculated column. The |
| | | word “total” implies a sum. System 110 |
| | | writes a summary-calculated-value- |
| | | expression for the sum. |
| Is that the last summary value? | yes | |
| I can call you to collect this | yes | |
| information is that OK? | | |
| How often should I call you? | daily | If the Customer calls in and journal data |
| | | is collected, the Customer may not be |
| | | called because the journal will appear |
| | | complete without any missing data |
| What time of day is best for you? | 8 pm | |
| Would you like the report sent to | no | |
| your email address? | | |
| Would you like the report FAXed | yes | |
| to you? | | |
| What is your FAX number? | 800-555-1234 | |
| Thank you. I hope to hear from | Good bye. | The site corresponding to the spoken |
| you soon. You may edit any of | | URL may be hosted by communication |
| this information on my website | | system 110 (e.g., data managing engine |
| <url>. Good bye. | | 126 in combination with engines 134 and |
| | | 136) to allow a Customer to rewrite, |
| | | revise, delete, supplement, update, or add |
| | | to any information that was spoken or |
| | | concluded from an exchange of spoken |
| | | information. The website may also |
| | | provide security functions for identifying |
| | | the Customer to communication system |
| | | 110 at the onset of a call. |

A communication system, according to various aspects of the present invention, collects data and meta-data from spoken information. To collect meta-data, a prompt to the customer by a persona may include meta-meta data. Collecting may include soliciting, perceiving, storing, and/or scheduling. Soliciting may include receiving inquiries prompted by tickler advertising, explaining services, and obtaining cooperation from a prospect (now a Customer). Soliciting may include selecting a prospect and a delivery address (e.g., a phone number), then initiating a call and conducting a conversation and/or a survey with the person who answers the call as discussed above.

Journaling, according to various aspects of the present invention, may include receiving data, storing the data in accordance with meta-data, and reporting the data in accordance with the meta-data. The meta-data may be determined by asking the Customer for a choice among sets of meta-data. The meta-data may be determined by asking the Customer for values to be used as meta-data.

Collecting, according to various aspects of the present invention, may include determining that meta-data for a journal is incomplete (e.g., missing, inconsistent), prompting a Customer to obtain the meta-data, and performing any journal function in accordance with the meta-data. Prompting the Customer may include initiating a call and/or a conversation as discussed above. The prompt may include meta-meta-data.

Collecting, according to various aspects of the present invention, may include limiting the duration and/or the complexity (number of topics) of a conversation to a predetermined maximum quantity. Imposing such a limit (e.g., by terminating a conversation before a script or survey is complete) may consequently create missing or inconsistent data and/or meta-data leading to future collecting of the missing data and/or meta-data. For example, a survey may be conducted in stages, journaling (e.g., creating and updating journals) may be conducted in stages, and/or the stages for surveying and journaling may be intermixed (e.g., in the same call or in a series of calls). Limiting, conducting surveys and/or journaling in stages, and intermixing may balance the benefits of the Customer and the Company.

According to various aspects of the present invention, reporting may be accomplished in accordance with meta-data determined by the Customer via spoken information. Obtaining meta-data for reporting and collecting other information (e.g., entries for journals, entries for surveys) may each be conducted in stages, and the stages for obtaining meta-data for reporting and the stages for collecting other information may be intermixed (e.g., in the same call or in a series of calls). Intermixing may balance the benefits to the Customer and the Company.

According to various aspects of the present invention, named sets of meta-data may be offered to a particular Customer. For example, one or more journal definitions may be offered in a script by a persona as a selection from which the particular Customer may choose. By choosing a named set of meta-data, a constructing engine and/or a data managing engine may cooperate to instantiate one or more journals specifically for the particular Customer, avoiding the collection of some or all meta-data from the particular Customer. To allow some Customer customizations, a particular set of meta-data may omit some meta-data that may be collected after the choice of the particular set is made.

According to various aspects of the present invention, a system for journaling spoken information may, in any practical order: (a) offer a set of choices to a Customer for preparing a journal; (b) accept a designation of a member of the set; (c) instantiate a journal according to the designated member; (d) accept first data from the Customer; (e) store the first data in the journal; (f) determine that a record of the journal is missing or incomplete; and (e) collect second data from the Customer to add or complete the missing or incomplete record. The system may further include the first and the second data in a report to the Customer. The system may further collect data from the Customer for a survey, collect data for a purchase order from the Customer, and/or advertise a product or service to the Customer.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A communication system for exchanging spoken information with a person, the communication system comprising:
a meta-data database;
a constructing engine that directs collecting of meta-data and that directs constructing a journal in accordance with the meta-data database; and
a conversing engine for exchanging spoken information with the person, wherein the conversing engine collects the meta-data from the person for storage in the meta-data database and collects data from the person for storage in the journal.

2. The communication system of claim 1 wherein collecting the meta-data is accomplished via a first call and collecting the data is accomplished via a second call.

3. The communication system of claim 1 wherein the conversing engine collects a response from the person for a survey.

4. A communication system for exchanging spoken information with a person, the communication system comprising:
a conversing engine for exchanging spoken information with the person, wherein:
the conversing engine offers a set of choices to the person and accepts a response that indicates a choice, the choice identified to a set of meta-data; and
the conversing engine collects data from the person for storage in a journal; and
a constructing engine that directs constructing of the journal in accordance with the set of meta-data.

5. The communication system of claim 4 wherein accepting the response is accomplished via a first call and collecting the data is accomplished via a second call.

6. The communication system of claim 4 wherein the conversing engine collects a second response from the person for a survey.

7. A method performed by a communication system, the communication system from time to time exchanging spoken information with a plurality of users, the method comprising:
collecting information from a first user of the plurality of users for entry into a journal identified to the first user;
collecting respective opinions from a multiplicity of users of the plurality of users;
reporting to the first user in accordance with the journal; and
reporting to a second user of the plurality of users in accordance with the opinions.
